(19) United States
(12) Patent Application Publication
(10) Pub. No.: US 2002/0164458 A1
(43) Pub. Date: Nov. 7, 2002

(54) Electromagnetic wave-shielding construction material and method for producing the same

(76) Inventors: Kazuhiro Suga, Tokyo-to (JP); Hironori Kamiyama, Tokyo-to (JP); Michio Nishi, Tokyo (JP); Katsumi Tada, Tokyo (JP); Tetsuo Endo, Tokyo (JP); Kiyomitsu Hasegawa, Tokyo (JP); Akira Nonaka, Tokyo (JP)

Correspondence Address: LADAS & PARRY, 224 SOUTH MICHIGAN AVENUE, SUITE 1200, CHICAGO, IL, 60604, US

(21) Appl. No.: 09/995,062

(22) Filed: Nov. 27, 2001

(30) Foreign Application Priority Data
Mar. 2, 2001 (JP) 2001-058208

(51) Int. Cl. B32B 3/00

(52) U.S. Cl. 428/195

(57) ABSTRACT

The main object of the present invention is to provide an electromagnetic wave-shielding construction material which can cut-off electromagnetic waves at low costs in an efficient manner and a method for the production of the electromagnetic wave-shielding construction material. In order to achieve the above-mentioned object, the present invention provides an electromagnetic wave-shielding construction material comprising laminating an electromagnetic wave-shielding sheet, prepared by forming a conductive ink layer on one surface of a base material sheet by printing, on at least one plate surface of a panel section formed of a mixed material consisting of major panel components and a conductive material such that the conductive ink layer is in contact with the plate surface.

### BACKGROUND OF THE INVENTION

The present invention relates to a technical field of an electromagnetic wave-shielding construction material used for walls, floors and ceilings of architectures of which shielding from electromagnetic waves is demanded, these architectures including public facilities such as halls, hospitals and schools, buildings in industries, factories and houses.

Conventionally, applying an electromagnetic wave-shielding sheet to a plate construction material such as a gypsum board and the like is performed to improve the electromagnetic wave-shielding abilities of walls, floors and ceilings of architectures. As such an electromagnetic wave-shielding sheet, those prepared by coating the surface of a network material formed of glass fiber or the like net-wise with a conductive material as a conductive ink layer are used.

Particularly gypsum boards are used for the wall surfaces of many buildings as inexpensive, light-weight and easily constructible building materials. However, because this material itself has no electromagnetic wave-shielding ability, it cannot be used for buildings of which such an electromagnetic wave-shielding ability as aforementioned is required. For this, materials made to have electromagnetic wave-shielding ability by laminating a plate or foil of a conductive metal, such as iron and copper, on a gypsum board are used. However, these materials prepared by laminating such a metal plate or a metal foil on a gypsum board poses the problem of increased price. Also, in the case of laminating a metal plate in advance in a factory, the weight is increased, giving rise to a troublesome handling problem concerning, for example, conveyance. In the case of laminating a metal plate at site, working process are increased. In any case, metal processing is required and no advantage is therefore taken of the gypsum board.

Gypsum boards, in turn, are known which are used as electromagnetic wave-shielding construction materials having electromagnetic wave-shielding ability. FIG. 7(A) shows a partly broken perspective view of this conventional gypsum board and FIG. 7(B) shows a horizontal sectional view of the gypsum board. This gypsum board 20, as is illustrated, has a structure in which a rectangular conductive network plate 24 having almost the same area of the backface of a rectangular panel section 21 is embedded in the backface side of the panel section 21 in almost parallel to the backface and a front paper 22 and a back paper 23 are applied to the front surface and backface of the panel section 21 respectively. In these FIG. 7(A) and FIG. 7(B), the arrow shows the direction of incidence of an electromagnetic wave.

The aforementioned gypsum board 20 is manufactured, for example, in the following manner. Specifically, the front paper 22 is supplied to the upside of a molding framework moved by a belt conveyer from a roll on which the front paper 22 is wound, with the conductive network plate 24 being supplied to the upside of the front paper 22 from a roll on which the conductive network plate 24 is wound, at the same time a mixed material to be the structural material of the above panel section 21 is supplied to the upside of these front paper 22 and conductive network plate 24 and further the back paper 23 is supplied to the upside of the mixed material from a roll on which the back paper 23 is wound, to thereby mold a lengthy and continuous gypsum board having a desired thickness. This lengthy gypsum board fed by the belt conveyer is cut into lengths of 1820 mm. Thus, 1820-mm-long and 910-mm-wide rectangular gypsum boards 20 with predetermined thicknesses (e.g., 9.5 mm, 12.5 mm and 15 mm) are continuously obtained.

The aforementioned mixed material is a mixed one prepared by mixing a carbon material having a particle diameter of 100 μm or less in a weight ratio of 10 wt % and a carbon fiber material having a length of 6 mm or less in a weight ratio of 2 wt % respectively in major components consisting of, for example, calcined gypsum, a forming agent, a curing control agent, an adhesive adjuvant and clay (mineral) and by adding water to the resulting mixture.

Also, the aforementioned conductive network plate 24 is made to have a shape with grid-like openings by using a wire rod made of a conductive material such as gold, silver, copper, stainless, aluminum, zinc, nickel or carbon or a wire rod prepared by coating the surface of a polymer fiber or a glass fiber with a film of the aforementioned conductive material.

The aforementioned gypsum board 20, as shown in FIG. 7(B), has a three-layer structure comprising a dielectric (a gypsum structure section 21a on the front side) having a resistance of 100 Ω/□ or less and an absolute complex specific inductive capacity of 5 to 1200 per unit, the conductive network plate 24 having a resistance of 10Ω/cm or less and a dielectric (a gypsum structure section 21b on the backside) having a resistance of 100 Ω/□ or less and an absolute complex specific inductive capacity of 5 to 1200 per unit as viewed from the direction of incidence of an electromagnetic wave and exhibits an electromagnetic shielding ability of at least 40 dB in a frequency band ranging from 30 MHz to 10 GHz.

However, the electromagnetic wave-shielding sheet which is conventionally used poses the problem that it is fragile fundamentally because it uses fibers such as glass fiber. Also, the thickness of the coating is uniformed with difficulty since the fiber is coated with the conductive material as an electroconductive wave reflector. Therefore, there is the problem that these conventional sheets are of widely uneven electromagnetic wave-shielding abilities and no sheet having a uniform electromagnetic wave-shielding ability and stable qualities is not obtained.

On the other hand, the aforementioned gypsum board 20 as a conventional electromagnetic wave-shielding building material involves such a problem that since the conductive network plate 24 is inserted into the panel section 21, a manufacturing difficulty arises, the manufacturing yield is decreased and the production cost is increased.

Also, since its base material is fiber, the conductive network plate 24 has low strength, causing uneven electromagnetic wave-shielding abilities of products in a unit lot (roll) on account of the breaking of wire and slippage. Particularly, during the course of embedding the aforementioned conductive network material 24 in the mixed material, defective parts are easily caused by the braking of wire and slippage of the conductive network material 24 at both side parts of a molding frame. Therefore, there is the problem that no gypsum board having constant electromagnetic wave-shielding abilities and stable qualities is obtained.

### SUMMARY OF THE INVENTION

The present invention has been made in view of such a situation as aforementioned, and it is an object of the present invention to provide an electromagnetic wave-shielding construction material which can cut-off electromagnetic waves at low costs in an efficient manner and a method for the production of the electromagnetic wave-shielding construction material.

The above object is attained by an electromagnetic wave-shielding construction material according to the present invention, the electromagnetic wave-shielding construction material comprising laminating an electromagnetic wave-shielding sheet, prepared by forming a conductive ink layer on one surface of a base material sheet by printing, on at least one plate surface of a panel section formed of a mixed material consisting of major panel components and a conductive material such that the conductive ink layer is in contact with the plate surface.

The conductive ink layer in the electromagnetic wave-shielding sheet is preferably formed net-wise, and in this case, the line width of the conductive ink layer is preferably 0.5 mm or more and the opening ratio of the conductive ink layer is preferably 30% or more.

Also, a composition containing a polyol as its major component and an isocyanate compound as a crosslinking agent is used as a vehicle of the ink forming the conductive ink layer in the electromagnetic wave-shielding sheet.

A method for producing the aforementioned electromagnetic wave-shielding construction material comprises laminating the electromagnetic wave-shielding sheet on at least one plate surface of the panel section such that the conductive ink layer is in contact with the plate surface.

In this production method, it is preferable that a composition containing a polyol as its major component and an isocyanate compound as a crosslinking agent be used as a vehicle of the ink forming the conductive ink layer and the conductive ink layer be cured by heating in the process of laminating the panel section and the electromagnetic wave-shielding sheet.

A method for producing an electromagnetic wave-shielding construction material according to the present invention comprising feeding a first sheet from a first roll, supplying a mixed material of major components of a panel and a conductive material to the upside of the first sheet and supplying a second sheet to the upside of the mixed material from a second roll, to form a lengthy electromagnetic wave-shielding construction material provided with sheets stuck to the upper and lower surfaces of the panel section and cutting this construction material into predetermined lengths to thereby obtain an electromagnetic wave-shielding construction material having a predetermined form, wherein an electromagnetic wave-shielding sheet prepared by forming a conductive ink layer on one surface of a base material sheet by printing is used as at least one of the aforementioned first sheet and second sheet.

In the method of producing the electromagnetic wave-shielding construction material, the conductive ink layer in the electromagnetic wave-shielding sheet is preferably formed net-wise.

As explained as above, the electromagnetic wave-shielding construction material of the present invention has a structure comprising laminating an electromagnetic wave-shielding sheet, prepared by forming a conductive ink layer on one surface of a base material sheet by printing, on at least one plate surface of a panel section formed of a mixed material consisting of major panel components and a conductive material such that the conductive ink layer is in contact with the plate surface. Therefore, it is possible to cut off electromagnetic waves in an efficient manner without raising the conductivity of the panel section itself and stable electromagnetic wave-shielding ability with no dispersion can be obtained. Also, since the electromagnetic wave-shielding construction material of the present invention can be produced in the same production process that is conventionally used, it is produced with ease and production yield can be improved, whereby production costs can be suppressed.

### BRIEF DESCRIPTION OF THE DRAWINGS

FIG. 1 is a sectional view illustrating an electromagnetic wave-shielding gypsum board as an electromagnetic wave-shielding construction material according to the present invention;

FIG. 2 is an explanatory view illustrating the pattern of a conductive ink layer;

FIG. 3 is an explanatory view showing one example of a production line of an electromagnetic wave-shielding construction material according to the present invention;

FIG. 4 is a partly broken perspective view and a horizontal sectional view showing an electromagnetic wave-shielding gypsum board produced in Example;

FIG. 5 is a graph for comparing a gypsum board obtained in Example with a conventional gypsum board in electromagnetic wave-shielding ability to a horizontally polarized wave;

FIG. 6 is a graph for comparing a gypsum board obtained in Example with a conventional gypsum board in electromagnetic wave-shielding ability to a vertically polarized wave; and

FIG. 7 is a partly broken perspective view and a horizontal sectional view showing a conventional gypsum board having an electromagnetic wave-shielding ability.

### DESCRIPTION OF THE PREFERRED EMBODIMENT

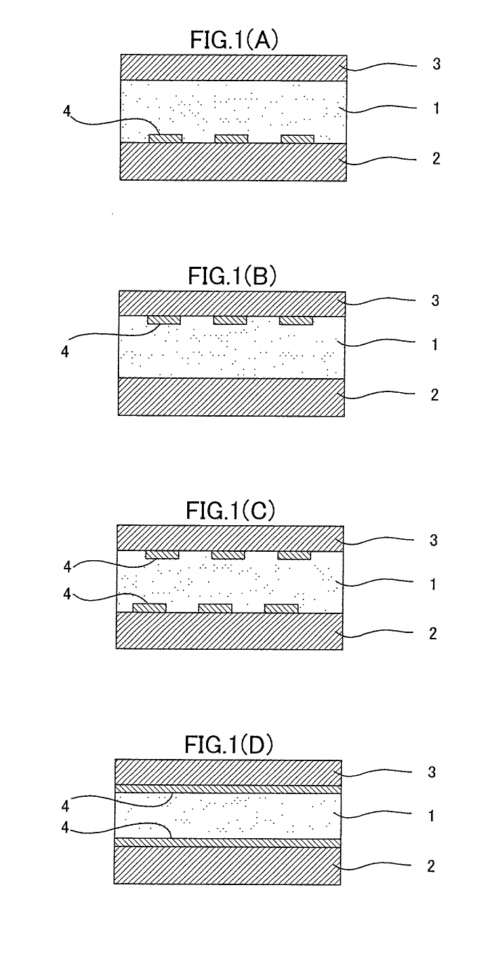

FIG. 1(A) to FIG. 1(D) are sectional views illustrating an electromagnetic wave-shielding gypsum board as an electromagnetic wave-shielding construction material according to the present invention. In these figures, 1 represents a panel section and board papers 2 and 3 are laminated on both surfaces of the panel section 1 respectively, wherein an electromagnetic wave-shielding sheet is used on at least one of these board papers.

The electromagnetic wave-shielding gypsum board shown in FIG. 1(A) is a type using an electromagnetic wave-shielding sheet made of the board paper 2, on which a conductive ink layer 4 is printed pattern-wise, on the front side of the panel section 1. The electromagnetic wave-shielding gypsum board shown in FIG. 1(B) is a type using an electromagnetic wave-shielding sheet made of the board paper 3, on which the conductive ink layer 4 is printed pattern-wise, on the backside of the panel section 1, respectively. The electromagnetic wave-shielding gypsum board shown in FIG. 1(C) is a type using the board papers 2 and 3, on which the conductive ink layers 4 are printed pattern-wise as electromagnetic wave-shielding sheets, on the front side and backside of the panel section 1, respectively. The electromagnetic wave-shielding gypsum board shown in FIG. 1(D) is a type using the board papers 2 and 3, on which the conductive ink layers 4 are printed on the entire surfaces as electromagnetic wave-shielding sheets, on the front side and backside of the panel section 1.

In all of these electromagnetic wave-shielding gypsum board, the conductive ink layer 4 is preferably put in such a state that it is in contact with the panel section 1 as shown in the figure. Such a positional relationship is preferable because the color and gloss (usually black or metallic gross) of the conductive ink layer 4 are shielded by the backface of the board paper and therefore scarcely affect the outward design of the gypsum board and also the conductive ink layer 4 is neither worn nor rusted with ease. It is to be noted that the electromagnetic wave-shielding sheet provided with the conductive ink layer 4 printed on one surface of the board paper in this manner may be used on either one of the front side and the backside or on both sides.

For gypsum as a major component constituting the panel section of the electromagnetic wave-shielding gypsum board, a material used as a usual gypsum board is used. Specifically, besides mainly gypsum hemihydrate (CaSO₄.1/2H₂O), one or both of gypsum dihydrate (CaSO₄.2H₂O) and anhydrous gypsum (CaSO₄) may be contained. By adding a powder of a conductive material to this gypsum material, conductivity is developed to stimulate the decay of electromagnetic waves. In addition, this composition as a dielectric causes the reflection of electromagnetic waves due to dielectric polarization of incident electromagnetic waves with the result that it has high electromagnetic wave-shielding ability. The thickness of the panel section is designed to be about 6 to 20 mm, the surface resistance is designed to be 1 to 10³ Ω/□ and preferably 10 to 100 Ω/□ and the absolute complex specific inductive capacity of the panel section is designed to be 10 to 1000.

As the conductive material to be mixed in the major components of the panel section, conductive carbon such as graphite is desirable in view of balance between costs and qualities. Besides carbon, conductive metals such as palladium, nickel, gold, platinum and silver may also be used. In addition, two or more types of these compounds may be mixed. Because aluminum and copper enter into a chemical reaction with an alkali component of the gypsum, decreasing the conductivity and these metals are therefore undesirable in the case of a gypsum board. The shape of the powder includes a scale form, short fiber form and polygonal form. A powder having an average particle diameter of 1 to 30 μm is used. The amount of the powder to be added is designed to be about 4 to 70 mass % and more preferably about 20 to 70 mass %.

A desirable conductive material in the case where the panel is a gypsum board is constituted by mixing at least a carbon fiber material in a weight ratio of 1 wt % or more and a carbon material having a particle diameter of 100 μm or less in weight ratio of 5 wt % or more. In this case, when the weight ratio of the major components of the panel section is 30 wt % or less, the strength of the panel section is significantly reduced and the weight ratio of the major components is preferably made to be more than the above ratio. Also, the aforementioned carbon fiber preferably contains a fiber having a length of 6 mm or less in a weight ratio of 3 wt % or less. This is because when a carbon fiber material 6 mm or more in length is mixed or the weight ratio is made to be 3 wt % or more, the carbon fiber material largely expands and is not hence well-mixed.

The electromagnetic wave-shielding sheet is prepared by printing a conductive ink layer on one surface of a base material sheet such as paper. Therefore, this electromagnetic wave-shielding sheet has a higher strength and more reduced in the dispersion of quality than conventional electromagnetic wave-shielding sheets and becomes a qualitatively stable one having a uniform electromagnetic wave-shielding ability.

As the base material sheet constituting the electromagnetic wave-shielding sheet, a-sheet material other than paper may be used. In the case where the base material sheet is applied to the panel section to form the electromagnetic wave-shielding gypsum board as shown in FIG. 1, usual gypsum board paper may be used and paper regenerated from waste paper is usually used. It is desirable that board paper having a basis weight of about 50 to 300 g/m² be used as the backside board paper and board paper having a basis weight of about 150 to 300 g/m² be used as the front side board paper on the side of incidence of electromagnetic waves. These board papers are preferably supplied in a roll form.

As the ink forming the conductive ink layer on the base material sheet, those capable of imparting conductivity may be used and ink prepared by adding a powder of a conductive material to a binder resin may be used.

As the binder resin, cellulose (fibrin) type resins such as cellulose nitrate, acetyl cellulose and cellulose acetate propionate, acrylic resins such as polymethyl (meth) acrylate and polybutyl (meth) acrylate (here, (meth) acryl means acryl or methacryl), vinyl chloride/vinyl acetate copolymers, polyester resins, polyvinylbutyral and polyurethane resins may be used singly or as mixtures of two or more.

As the powder of a conductive material, the same materials as those added to the panel section, for example, conductive metals such as gold, silver, copper, stainless, aluminum, zinc, tin and nickel, particle of conductive materials such as graphite and carbon or those prepared by mixing these conductive materials in an amount of about 5 to 70 mass % and more preferably about 50 to 70 mass % may be used. As to the shape of these particles, particles having a scale form or a short fiber form are preferably used.

The polyurethane resin to be used as the vehicle of the ink is a composition containing polyol (polyhydric alcohol) as its major component and an isocyanate compound as a crosslinking agent (hardener).

The polyol includes those containing two or more hydroxyl groups in its molecule and basically monomer diols or triols and polymer diols or triols containing an alkylene repeat unit chain contributing primarily to the molecular weight. Typical polymer polyols substantially comprise a straight chain or a branched chain of the above repeat unit which is terminated by a hydroxy group and preferably include a monomer polyol having 2, 3, 4 or more hydroxy groups. Examples of the monomer polyol include ethylene glycol, propylene glycol, glycerol, trimethylol propane, 1,2,6-hexanetriol, butenediol, sucrose, glucose, sorbitol, pentaerythritol, mannitol, triethanolamine, n-methanedimethanolamine, cyclic aromatics and aliphatics and triols. Moreover, polyethylene glycol, polypropylene glycol, acryl polyols, polyester polyols and polyether polyols may be used.

On the other hand, as the isocyanate compound, polyvalent isocyanate compounds having two or more isocyanate groups in the molecule are used. Examples of the isocyanate compound which may be used include aromatic isocyanate compounds such as 2,4-tolylenediisocyanate, 2,6-tolyelenediisocyanate, diphenylmethane-4,4′-diisocyanate, polyphenylmethanepolyisocyanate called crude MDI and xylylenediisocyanate, aliphatic and/or alicyclicisocyanate compounds such as isophoronediisocyanate, hexamethylenediisocyanate, dicyclohexylmethane-4,4′-diisocyanate and triphenylmethanetriisocyanate, hydrogenated isocyanate compounds such as hydrogenated tolylenediisocyanate and hydrogenated diphenylmethanediisocyanate, or isocyanate adducts such as isocyanate terminal low molecular adducts obtained by reacting a polyisocyanate compound with a low molecular glycol or triol, for example, dipropylene glycol, 1,6-hexanediol, 1,2,6-hexanetriol and trimethylolpropane or isocyanate polymers such as tolylenediisocyanate trimers.

The aforementioned isocyanate may be, though may be used singly, used as a block isocyanate which is to be used in a system in which a blocking agent as will be explained later is addition-reacted with an isocyanate group and heated by using a dissociation catalyst together optionally during crosslinking and curing to resolve blocking. Also, a single isocyanate, even if it is a liquid at ambient temperature, may be used by solidifying it. Because the use of the isocyanate as the block isocyanate ensures that the conductive ink layer formed on the electromagnetic-shielding sheet is prevented from crosslinking and curing, adhesion to the panel section is scarcely lowered with time even if the conductive ink layer is formed in advance. Because a large number of electromagnetic wave-shielding sheets is manufactured in advance and thereafter can be transferred to a process of laminating the panel section, this black isocyanate is very advantageous in light of production process and an electromagnetic wave-shielding construction material having high layer adhesive strength is obtained by the use of this block isocyanate.

Examples of the blocking agent include phenol type blocking agents such as phenol, cresol, xylenol, p-ethylphenol, o-isopropylphenol, p-tert-butylphenol, p-tert-octylphenol, thymol, p-naphthol, p-nitrophenol and p-chlorophenol, alcohol type blocking agents such as methanol, ethanol, propanol, butanol, ethylene glycol, methyl cellosolve, butyl cellosolve, methyl carbitol, benzyl alcohol, phenyl cellosolve, furfuryl alcohol and cyclohexanol, active methylene types such as dimethyl malonate, diethyl malonate and ethyl acetoacetate, mercaptan type blocking agents such as butylmercaptan, thiophenol and tert-dodecylmercaptan, acid amide type blocking agents such as acetanilide, acetanisidide, acetic acid amide and benzamide, imide type blocking agents such as succinic acid imide and maleic acid imide, amine type blocking agents such as diphenylamine, phenylnaphthylamine, aniline and carbazole, imidazole type blocking agents such as imidazole and 2-ethylimidazole, urea type blocking agents such as urea, thiourea and ethyleneurea, carbamate type blocking agents such as phenyl N-phenylcarbamate and 2-oxazolidone, imine type blocking agents such as ethyleneimine, oxime type blocking agents such as formaldoxime, acetaldoxime, methylethylketoxime and cyclohexanone oxime and sulfurous acid type blocking agents such as sodium bisulfite and potassium bisulfite. The block of the isocyanate is preferably made to resolve at the temperature when the electromagnetic wave-shielding sheet and the panel section are molded under heating.

As a method of printing the conductive ink layer to be formed on the base material sheet, a silk screen method is preferable because the amount to be applied can be increased and blurring is reduced and a rotary silk screen printing method is most preferable because it enables continuous printing. Also, if highly conductive ink is used, the amount to be applied can be decreased and therefore the conductive ink layer can be formed even by gravure printing.

The aforementioned electromagnetic wave-shielding gypsum board uses board paper provided with conductivity as the electromagnetic wave-shielding sheet. If it is intended to provide sufficient electromagnetic wave-shielding ability by adding a powder of an electroconductive material in a large amount only to the panel section, this causes a reduction in the strength of the panel section (plate), a reduction in moldability and a steep rise in cost. Therefore, this board paper is convenient because the board paper too is made to share the capability of conductivity.

The resistance (evaluated by surface resistance or volume resistivity) of the conductive ink layer is preferably lower than that of the panel section. This makes it possible to decrease the load as to the amount of the conductive material to be added to the panel section. For this, only the use of a conductive carbon powder does not satisfy the required performance whereas only the use of silver brings about high cost and it is therefore preferable to compound the both. The compounding ratio by mass in this case, namely, silver powder/conductive carbon powder is made to be about 1/2 to 30/1 and the coating thickness is made to be about 3 to 30 g/m² (dry). It is to be noted that although nickel may be used, it must be contained in an amount larger than silver. In addition, the provision of the conductivity may be attained by combining conductive fibers with the board paper or by the deposition of a conductive material on the board paper.

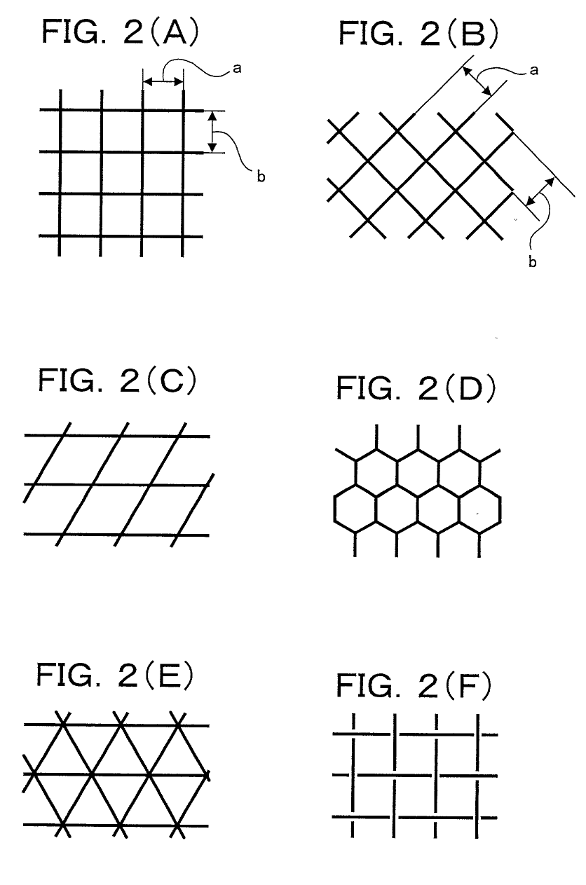

The entire surface of the conductive ink layer is preferably made to be a solid layer as shown in FIG. 1(D) in view of shielding ability (the degree of attenuation of the strength of electromagnetic waves) and the width of the frequency band of a shielding magnetic wave. When it is intended to decrease the cost of the conductive ink even though the shielding ability is lowered or it is intended to cut off only a specific frequency band, the conductive ink layers having the patterns illustrated in FIG. 2(A) to 2(F) are formed.

When the conductive ink layer is made to have a lattice (or network) pattern as shown in FIG. 2(A) and FIG. 2(B), the conductive ink layer functions as a low cut filter for cutting off low frequency band electromagnetic waves. Specifically, cut-off frequency fc [Hz] decided by the dimension of an opening portion exists and electromagnetic waves having frequencies less than fc are cut-off by the conductive ink layer whereas electromagnetic waves having frequencies exceeding fc enter into openings of the conductive ink layer and are transmitted through it. Approximately, this cut-off frequency fc may be regarded as the cut-off frequency f′c [Hz] of a waveguide having a section with the same shape and same dimension as the opening of the conductive ink layer. Namely, fc≈f′c. This approximation corresponds to the assumption that the openings as shown in FIG. 2(A) and FIG. 2(B) are regarded as waveguides with a very short length (depth).

When, as shown in FIG. 2(A) and FIG. 2(B), the lengths of both sides of the opening of the conductive ink layer are a [m] and b [m], the cut-off frequency fc of the opening, namely the cut-off frequency f′c [Hz] of the waveguide having a section with the same shape and same dimension as the opening is given by the following formula provided that a≧b as is well-known.

fc≈f′c=C/2a

Where C=2.998×10⁸ [m/sec], which is light velocity in vacuum (almost the same in air). In the case of a square lattice having, for example, the following dimensions: a=b=10 mm=1×10⁻², fc is given by the following equation.

fc≈1.5×10¹⁰ Hz=15 GHz

Accordingly, in this case, the conductive ink layer has the shielding ability to cut-off electromagnetic waves having frequencies lower than 15 GHz.

For example, in the case of considering uses for controlling domestic electric products in a room by using an electromagnetic wave having a frequency of 3 GHz (=3 ×10¹⁰ Hz) which is the frequency of a carrier wave, it is necessary for construction materials constituting walls, ceilings, floors or all of these portions not to cut-off but transmit the 3 GHz electromagnetic wave. Also, it is required for the construction materials to cut-off noises as to electromagnetic waves having frequencies other than the above frequency, particularly a frequency band lower than 3 GHz which frequency band exists in the surrounding circumstance and is used for or affects the operation of various domestic electric products. In this case, the cut-off frequency fc [Hz] may be set to a slightly lower value than 3 GHz. The length a of the longer side of the opening of the orthogonal lattice used to achieve the above object is determined as follows. Specifically, a which just satisfies the following condition: fc=3 GHz, is given by the following equation.

fc≈C/2a=3×10⁹ Hz

a=5×10⁻² m=50 mm

Therefore, it is understood that the dimension a to be found may be set to around 40 mm slightly lower than the calculated value 50 mm.

If the width of an opening of the conductive ink layer which is made into a lattice-like-network form is made too large, there is a fear that the shielding ability from electromagnetic waves having a frequency band which is an objective of shielding is not satisfied. Therefore, it is more preferable that the width be made as small as possible. When the width is made too small on the contrary, there is a fear that adhesion between the panel section and the conductive ink layer is decreased. For this, it is desirable to set the width of the opening of the network of the lattice to a minimum of about 4 mm square. If the width of the line of the conductive ink layer is narrowed (0.5 mm approximately), the opening ratio is made to 30% or more and up to about 90% and adhesion of the panel section to the conductive ink layer and to the base material sheet is secured, the width of the opening of the conductive ink layer may be small. Also, even if the width of the line of the conductive ink layer is narrowed, the opening ratio of the network of the conductive ink layer may be made small if adhesion between the panel section and the conductive ink layer is secured. However, if the width of a line of the conductive ink layer is narrowed, the problems of printing nonuniformity and blurring arise and therefore the width of the line is preferably designed to be 0.5 mm or more.

Therefore, when the conductive ink layer is made into a network form such as a lattice-like form, the diameter of the line of the network, width of the opening and opening ratio of the network may be set in consideration of adhesion to the panel section, a frequency band of electromagnetic waves which are the objective for shielding and printing nonuniformity and blurring. Specifically, as aforementioned, it is desirable that the line width of the conductive ink layer be 0.5 mm or more, the opening ratio of the network of the conductive ink layer be 30% or more and up to about 90% and the width of the opening of the network be about 4 mm square.

Even if a part of electromagnetic waves pass through the opening portion, the electromagnetic wave-shielding ability of the whole gypsum board is secured because the panel section 11 has conductivity and qualities as a dielectric which contribute to the effect of cutting-off electromagnetic waves.

Also, if conductive ink layers are formed on both sheets of the panel section and the corresponding opening portions of each ink layer are formed such that they are deviated from each other with respect to the direction of incidence of electromagnetic waves, electromagnetic wave-shielding ability can be maintained even if the opening ratio is set to a larger value.

A method for the production of the aforementioned electromagnetic wave-shielding gypsum board may be the same as a method for the production of a usual gypsum board. Also, a desired pattern (e.g., grain or rift) may be printed as required on the surface, backface or both external front and back surfaces of the board paper by using usual ink according to a known printing method.

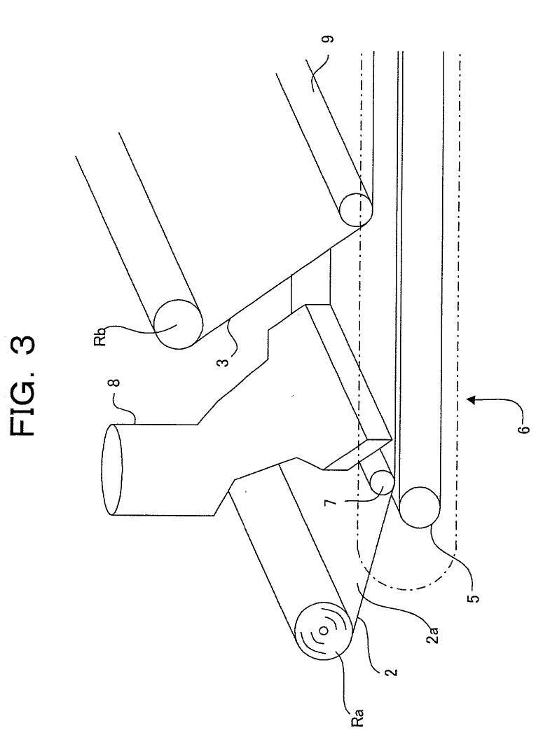

The aforementioned electromagnetic wave-shielding gypsum board is produced in a production line as illustrated in FIG. 3. For example, to explain the case of producing the electromagnetic wave-shielding gypsum board shown in FIG. 1(B), an electromagnetic wave-shielding sheet 3 is supplied to the upside of a molding framework 6moved by a belt conveyer 5 through a guide roll 7 from a roll Ra on which the electromagnetic wave-shielding sheet 3 as the front paper is wound, such that a print surface 3a of a conductive ink layer is disposed at the top. At the same time, a mixed material to be the structural material of the panel section 1 is supplied to the upside of the print surface 3a of the electromagnetic wave-shielding sheet 3 from a bucket 8. The supplied mixed material is thereby stuck to the conductive ink layer 4 of the electromagnetic wave-shielding sheet 3 and the conductive ink layer 4 is eventually stuck to the backface of the panel section 1. Further, a backside board paper 2 is supplied to the upside of the mixed material from a roll Rb on which the board paper 2 is wound. The upper side of the mixed material is pressed by the board paper 2 guided by a guide roll 9 to form a lengthy continuous gypsum board with a given thickness by molding. The lengthy gypsum board fed by a belt conveyer is cut to obtain, for example, 1820-mm-long and 910-mm-wide rectangular gypsum boards with thicknesses (e.g., 9.5 mm, 12.5 mm and 15 mm) continuously.

Because the electromagnetic wave-shielding gypsum board as the electromagnetic wave-shielding construction material of the present invention has the structure as aforementioned, it cuts off electromagnetic waves coming externally by reflection and absorption and therefore it can prevent these electromagnetic waves from transmitting through the gypsum board and entering into a room.

The electromagnetic wave-shielding gypsum board as the electromagnetic wave-shielding construction material of the present invention is also used for doors and partitions besides walls, floors and ceilings of architectures.

Electromagnetic wave-shielding gypsum boards of a type in which an electromagnetic wave-shielding sheet is applied to the backface (the side opposite to the direction of incidence of electromagnetic waves) of the panel section are used for interior construction materials for walls and ceilings. There is the case where a board formed using calcium silicate as its major component is used as interior construction materials for ceilings. Therefore, with regard also to the board formed using calcium silicate as its major component, ceiling interior construction materials having the same electromagnetic wave-shielding ability as the aforementioned gypsum board are obtained by applying the electromagnetic wave-shielding sheet of the present invention to the side opposite to the direction of incidence of electromagnetic waves such that the conductive ink layer is in contact with its major component.

Floor interior construction materials having the same effect as the aforementioned gypsum board are obtained by applying the aforementioned electromagnetic wave-shielding sheet to floor interior construction materials such as floor tiles, tile carpets, floor sheets and carpets which are formed using synthetic resins such as urethane, vinyl or synthetic rubber as the major component in the same manner as above.

Also, the aforementioned electromagnetic wave-shielding sheet maybe applied to exterior construction materials such as exterior boards. The electromagnetic wave-shielding sheets to be applied to exterior materials has a structure in which the conductive ink layer of the electromagnetic wave-shielding sheet is in contact with the plate surface of the panel section made of a mixed material prepared by mixing a major component material such as calcium silicate which is kneaded by adding water or a synthetic resin with a conductive material and various electromagnetic wave-shielding construction materials having the same effect as the aforementioned gypsum board are obtained. In this case, also, the electromagnetic wave-shielding sheet may be fitted to either one of the plate surfaces of the panel section such that the conductive ink layer is in contact with the plate surface.

It is to be noted that when the panel section is structured using water-curable inorganic materials, such as the aforementioned gypsum and calcium silicate, which are cured by adding water, the amount of a conductive material such as a carbon fiber material or a carbon material may be more decreased than in the case of the panel section using a synthetic resin because the conductivity of the panel section is made higher by the inclusion of water.

Also, in the above explanations, the electromagnetic wave-shielding sheet prepared by forming the network-like conductive ink layer by printing on one surface of a base material sheet such as paper is explained. However, electromagnetic wave-shielding sheets prepared by applying a network-like conductive ink layer made of a conductive material to the surface of a base material sheet or by embedding or interweaving a conductive ink layer in the surface of a base material sheet such that the network-like conductive ink layer made of a conductive material is disposed may be used. This structure may be attained, for example, by supplying a sheet such as paper to a molding framework as aforementioned and supplying a conductive network-like plate explained in the conventional example to the surface of this sheet, to apply the conductive network-like plate to the sheet or to embed or interweave the conductive network plate in the surface of the sheet.

### EXAMPLES

### Example 1

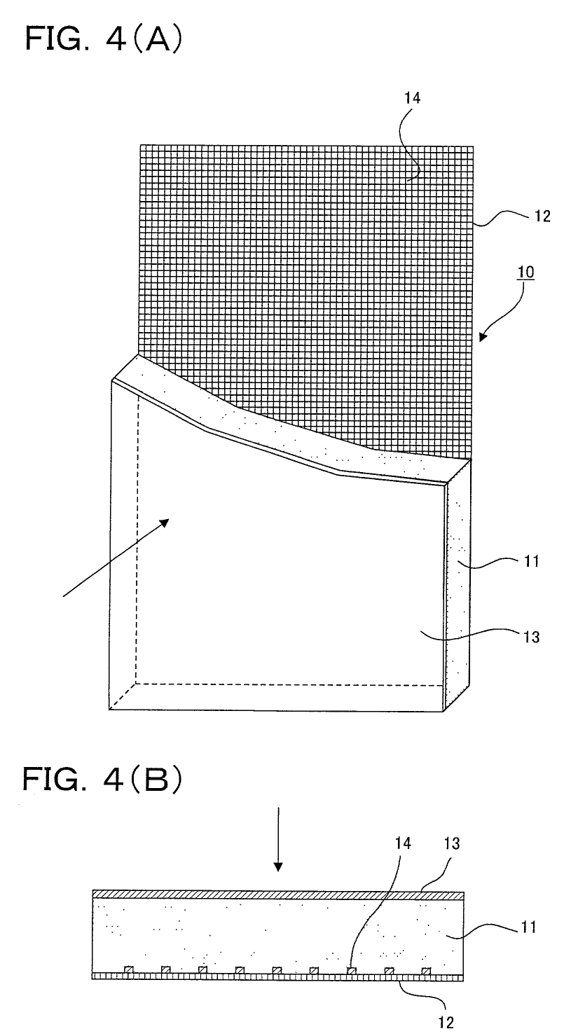

FIG. 4 shows an electromagnetic wave-shielding gypsum board as one example of an electromagnetic wave-shielding construction material, where in FIG. 4(A) is a partially broken perspective view and FIG. 4(B) is a lateral sectional view.

This gypsum board 10 was provided with an electromagnetic wave-shielding sheet 12 applied to one plate surface of a panel section 11 and with a board paper 13 applied to another plate surface. Specifically, if the side of incidence of electromagnetic waves as shown by the arrow is assumed to be the surface side, the board paper 13 was applied to the surface of the panel section 11 and the electromagnetic wave-shielding sheet 12 was applied to the backface of the panel section 11. The panel section 11 was formed of a mixed material prepared by mixing a carbon material having a particle diameter of 44 μm or less in a weight ratio of 10 wt % and a carbon fiber material having a length of 6 mm or less in a weight ratio of 2 wt % in major components consisting of baked gypsum, a foaming material, a hardening control agent, an adhesive adjuvant and clay (mineral) and by adding sufficient water, followed by sufficient kneading.

The electromagnetic wave-shielding sheet 12 was provided with a network-like conductive ink layer 14 which had grid-like openings in the inside thereof and was formed using conductive ink. To state in more detail, the network-like conductive ink layer 14 was printed on one board paper by using a conductive ink having the following composition prepared by mixing a silver scale-like particle with conductive carbon. As a binder resin in the conductive ink, polyester polyol was used and as a hardener, hexamethylenediisocyanate blocked by methylethylketoxime was used. The polyol and the blocked isocyanate hardener were used in a ratio of 10:2 respectively. The thickness of the conductive ink layer 14 was about 10±5 μm, the line width was about 2 mm, the opening ratio of the network was 44% and the width of the opening of the network was 4 mm square.

<Composition of Conductive Ink>

| | | |
|---|---|---|
| Silver powder: scale form having an average | 60 | mass % |
| particle diameter of 10 μm | | |
| Graphite powder: scale form having an | 4 | mass % |
| average particle diameter of 1 μm | | |
| Binder resin: polyester resin + block | 15 | mass % |
| isocyanate hardener | | |
| Diluting solvent | 21 | mass % |

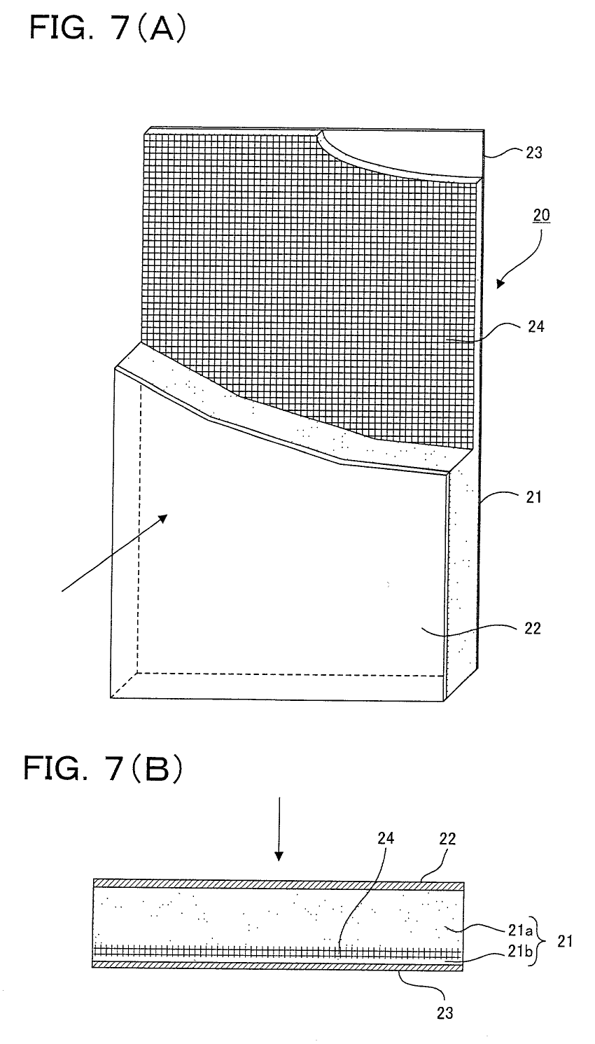

This gypsum board 10 was produced in the same production line as that shown in FIG. 3 and produced such that the backface of a panel section 11 was in contact with a conductive ink layer 14 of an electromagnetic wave-shielding sheet 12. The size of the gypsum board 10 was 1820×910 mm. A gypsum board was thereby obtained which had a two-layer structure consisting of the dielectric (panel section 11) having a resistance of 100 Ω/□ or less per unit and an absolute complex dielectric constant of 5 to 1200 and the conductive ink layer 14 having a resistance of 10 Ω/□ or less as viewed from the direction (direction of the arrow in FIG. 4(B)) of incidence of electromagnetic waves and had the same electromagnetic wave-shielding ability as the conventional gypsum board as shown in FIG. 7.

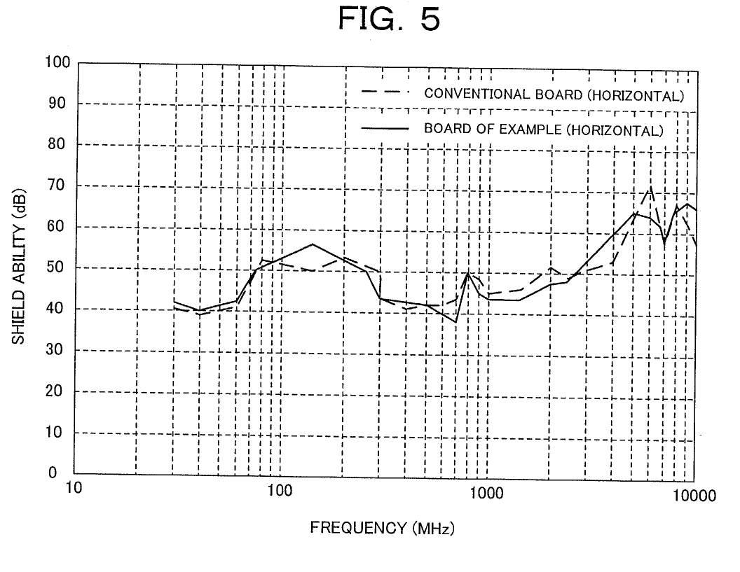

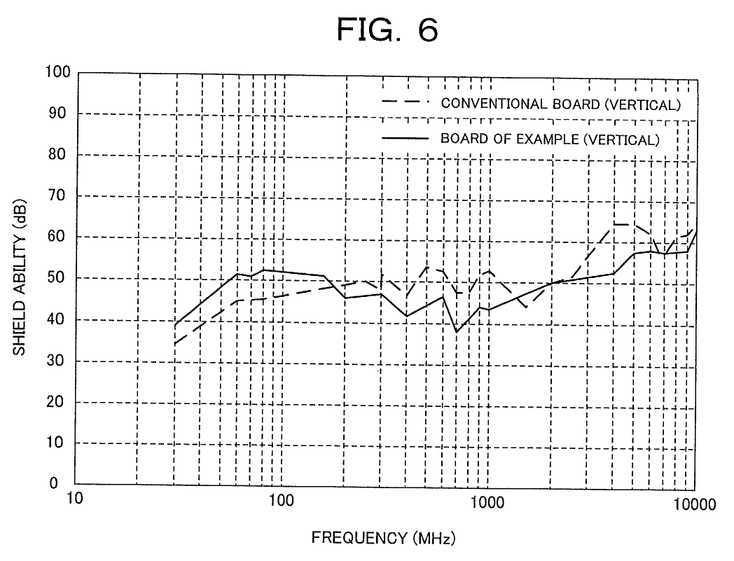

FIG. 5 and FIG. 6 are graphs showing the results of a comparison of the electromagnetic wave-shielding ability of the conventional gypsum board 20 having an electromagnetic wave-shielding ability as shown in FIG. 7 with that of the gypsum board 10, wherein FIG. 5 shows the results of shielding ability (=shield performance) against a horizontally polarized wave and also, FIG. 6 shows the results of shielding ability (=shield performance) against a vertically polarized wave.

As is clear from FIG. 5 and FIG. 6, the gypsum board 10 of the example has the same electromagnetic wave-shielding ability as the conventional gypsum board 20. Specifically, a gypsum board having an excellent electromagnetic wave-shielding ability as high as 40 dB or more in a wide frequency band ranging from 30 MHz to 10 GHz can be obtained. If this gypsum board 10 is used as interior materials to form a room, electromagnetic waves transmitting to the outside from the inside and vice versa can be cut-off and the malfunction and information transfer errors of communication devices which are caused by electromagnetic waves output from communication devices in a room can be prevented.

Unlike the conventional gypsum board 20 shown in FIG. 7, the gypsum board 10 of this example is free from the necessity for inserting the conductive network material 24 into the panel section 21 and it is only required to supply the electromagnetic wave-shielding sheet 12 as the back paper on which the conductive ink layer 14 is printed, to the upside of a molding framework. Therefore, the gypsum board 10 is easily produced and its production yield can be improved. Also, its production cost can be more suppressed than that of the conventional gypsum board 20.

Also, the print surface of the conductive ink layer is disposed on the backface adhesive side of the panel section and the electromagnetic wave-shielding sheet 12 is not embedded in the mixed material unlike the conventional conductive network material 24. Also, the paper as the base material of the electromagnetic wave-shielding sheet 12 is stronger than a conventional fiber. Therefore, problems such as breaking of wire and slippage of the electromagnetic wave-shielding sheet 12 scarcely arise. Also, the conductive ink layer 14 is formed by printing, leading to reduced qualitative dispersions. Accordingly, the gypsum board 10 is obtained which has a certain level of electromagnetic wave-shielding ability and stable qualities.

Specifically, a gypsum board is obtained which has high electromagnetic wave-shielding ability in a wide range of frequency, is easily produced, can improve production yield, can suppress production costs and has stable qualities.

Also, since the line width of the conductive ink layer 14 is set to about 2 mm, problems such as printing nonuniformity and blurring can be solved and a gypsum board which has a certain level of electromagnetic wave-shielding ability and stable qualities can be surely produced.

Also, as to the network of the conductive ink layer 14, an opening ratio of about 30% and an opening width of about 4 mm square were secured and therefore adhesion between the paper and the gypsum was obtained in the same manner as in the case of the conventional gypsum board in at least a portion other than the conductive ink layer 14. Even if ink with a resin binder highly adhesive to gypsum was not selected, the gypsum board 10 having a certain level of electromagnetic wave-shielding ability and stable qualities could be produced because adhesion between the panel section 11 and the conductive ink layer 14 was secured.

### Example 2

Using conductive ink comprising the same composition that was used in Example 1, a pattern consisting of a 1-mm-wide line is printed on an outdoor side board paper (back paper) having a basis weight of 230 g/cm² by using silk screen printing so as to form a square lattice (see FIG. 2(A)) with an opening portion having a side length of 10 mm, to form a conductive ink layer.

Next, a scale-like powder of graphite was mixed in gypsum to prepare a gypsum material having a surface resistance of 50 Ω/□. This gypsum material was poured on the above obtained conductive board paper and the surface of the gypsum material was covered with 160 g/m² of an indoor side board, followed by pressing under heat (pressed at 80° C. under a pressure of 5 kg/cm²) to obtain an electromagnetic wave-shielding gypsum board of 930×2100 mm.

### Comparative Example 1

The conductive ink layer was not formed in the above Example 2 to prepare a gypsum board as Comparative Example 1.

### Comparative Example 2

A gypsum board as Comparative Example 2 was produced in the same manner as in Example 2 except that the conductive ink layer was not formed and a fiber material comprising carbon fiber having a surface resistance of 5 Ω/cm which was woven almost grid-wise was sealed when the gypsum board was produced.

The electromagnetic wave-shielding ability of each of the gypsum boards obtained in Example 2 and Comparative Examples 1 and 2 in this manner was measured. Specifically, the electromagnetic wave-shielding ability was measured using a 2.5 GHz electromagnetic wave at 9 points in total, namely 3 points×3 points set by equally dividing the surface of each gypsum board lengthwise and breadthwise. The results are shown in Table 1.

TABLE 1

| | | Comparative | Comparative |
|---|---|---|---|
| Item | Example 2 | Example 1 | Example 2 |
| Electromagnetic | −31 dB | −17 dB | −31 dB |
| wave-shielding | | | |
| ability (average) | | | |
| Standard deviation | 0.8 dB | 1.5 dB | 3.2 dB |
| Maximum | −33 dB | −20 dB | −35 dB |
| Minimum | −30 dB | −15 dB | −25 dB |

As is understood from Table 1, the gypsum board of Example 2 has high electromagnetic wave-shielding ability and is reduced in the dispersion thereof depending on the measured position. On the other hand, the gypsum board of Comparative Example 1 which is provided with no conductive ink layer is inferior in electromagnetic wave-shielding ability and the gypsum board of Comparative Example 2 using carbon fiber is increased in the dispersion of the electromagnetic wave-shielding ability and is hence qualitatively unstable.

What is claimed is

1. An electromagnetic wave-shielding construction material comprising laminating an electromagnetic wave-shielding sheet, prepared by forming a conductive ink layer on one surface of a base material sheet by printing, on at least one plate surface of a panel section formed of a mixed material consisting of major panel components and a conductive material such that the conductive ink layer is in contact with the plate surface.

2. An electromagnetic wave-shielding construction material according to claim 1, wherein the conductive ink layer in the electromagnetic wave-shielding sheet is formed net-wise

3. An electromagnetic wave-shielding construction material according to claim 2, wherein the line width of the conductive ink layer is 0.5 mm or more and the opening ratio of the conductive ink layer is 30% or more.

4. An electromagnetic wave-shielding construction material according to claim 1, wherein a composition containing a polyol as its major component and an isocyanate compound as a crosslinking agent is used as a vehicle of the ink forming the conductive ink layer in the electromagnetic wave-shielding sheet.

5. An electromagnetic wave-shielding construction material according to claim 2, wherein a composition containing a polyol as its major component and an isocyanate compound as a crosslinking agent is used as a vehicle of the ink forming the conductive ink layer in the electromagnetic wave-shielding sheet.

6. An electromagnetic wave-shielding construction material according to 3, wherein a composition containing a polyol as its major component and an isocyanate compound as a crosslinking agent is used as a vehicle of the ink forming the conductive ink layer in the electromagnetic wave-shielding sheet.

7. A method for producing the electromagnetic wave-shielding construction material as claimed in claim 1, the method comprising laminating the electromagnetic wave-shielding sheet on at least one plate surface of the panel section in the condition that the conductive ink layer is in contact with the plate surface.

8. A method for producing the electromagnetic wave-shielding construction material according to claim 7, a composition containing a polyol as its major component and an isocyanate compound as a crosslinking agent is used as a vehicle of the ink forming the conductive ink layer and the conductive ink layer is cured by heating in the process of laminating the panel section and the electromagnetic wave-shielding sheet.

9. A method for producing an electromagnetic wave-shielding construction material, the method comprising feeding a first sheet from a first roll, supplying a mixed material of major components of a panel and a conductive material to the upside of the first sheet and supplying a second sheet to the upside of the mixed material from a second roll, to form a lengthy electromagnetic wave-shielding construction material provided with sheets stuck to the upper and lower surfaces of the panel section and cutting the construction material into predetermined lengths to thereby obtain an electromagnetic wave-shielding construction material having a predetermined form, wherein an electromagnetic wave-shielding sheet prepared by forming a conductive ink layer on one surface of a base material sheet by printing is used as at least one of said first sheet and second sheet.

10. A method for producing an electromagnetic wave-shielding construction material according to claim 9, wherein the conductive ink layer in the electromagnetic wave-shielding sheet is formed net-wise.
